(19) United States
(12) Patent Application Publication
(10) Pub. No.: US 2025/0164859 A1
(43) Pub. Date: May 22, 2025

(54) MONITORING CAMERA

(71) Applicant: i-PRO CO., LTD., Tokyo (JP)

(72) Inventor: Shinichiro OKAMURA, Tokyo (JP)

(73) Assignee: i-PRO CO., LTD., Tokyo (JP)

(21) Appl. No.: 18/836,274

(22) PCT Filed: Jan. 20, 2023
(86) PCT No.: PCT/JP2023/001791

§ 371 Date: Aug. 6, 2024

(30) Foreign Application Priority Data
Feb. 7, 2022 (JP) 2022-017266

(51) Int. Cl. G03B 17/08; H04N 23/51

(52) U.S. Cl. CPC G03B 17/08; H04N 23/51; G03B 2217/002

(57) ABSTRACT

This monitoring camera comprises a casing, a housing portion that is provided within the casing, at least one cover that is attached to the casing, an elastic portion that is disposed between the casing and the cover and has a through hole, and a shaft portion that has a larger diameter than the through hole and protrudes from the cover toward the housing portion in the casing opposite thereto. The through hole rotatably holds the shaft portion, which is inserted through the through hole and into the housing portion.

### TECHNICAL FIELD

The present disclosure relates to a surveillance camera

### BACKGROUND ART

Patent Literature 1 discloses a parameter setting support system in which a surveillance camera and a terminal device are communicably connected to each other, input of parameters for each setting type other than image quality using a past video being played back is received by a user operation, and the parameters for each setting type are set.

### CITATION LIST

### Patent Literature

Patent Literature 1: JP2021-97299A

### SUMMARY OF INVENTION

### Technical Problem

In the related art, a surveillance camera has a configuration in which an external storage medium (for example, a USB memory, an SD card, or the like) for storing captured videos can be attached and detached. The surveillance camera includes a cover for attaching and detaching the external storage medium to and from a housing, and the external storage medium can be attached and detached by opening and closing the cover.

However, the surveillance camera is installed, for example, at a high place near a ceiling in order to capture a wide area. Therefore, an operator who installs the surveillance camera or replaces the external storage medium needs to remove the cover from the housing of the surveillance camera, attach and detach the external storage medium, and then reattach the cover at a high place, such as near a ceiling, where it is difficult to move. If the operator drops the removed cover during operation, the operator may have to go back and forth between an installation place of the surveillance camera and the ground to pick up the cover, or the operator may lose the cover.

The present disclosure has been made in view of the situations in the related art described above, and an object thereof is to improve the ease of attaching and detaching an external storage medium to and from a surveillance camera.

### Solution to Problem

The present disclosure provides a surveillance camera including a housing; a storage portion provided in the housing; at least one cover attached to the housing; an elastic portion disposed between the housing and the cover and having a through hole; and a shaft portion having a diameter larger than that of the through hole and protruding from the cover toward the storage portion of the housing facing the cover, in which the through hole rotatably holds the shaft portion that is inserted into the storage portion through the through hole.

### Advantageous Effects of Invention

According to the present disclosure, the ease of attaching and detaching an external storage medium to and from a surveillance camera can be improved.

### BRIEF DESCRIPTION OF DRAWINGS

FIG. 1 is an external perspective view of a surveillance camera according to a first embodiment.

FIG. 2 is an exploded perspective view of the surveillance camera shown in FIG. 1.

FIG. 3 is an exploded perspective view of a side surface of the surveillance camera.

FIG. 4 is an exploded perspective view of main parts of a side surface of a housing and a side cover.

FIG. 5 is a perspective cross-sectional view of main parts when a shaft portion of the side cover is attached to the side surface of the housing.

FIG. 6 is an explanatory diagram showing an operation procedure when opening and closing the side cover.

FIG. 7 is a cross-sectional view of main parts showing the operation procedure when opening and closing the side cover.

FIG. 8 is a side view of the housing when side covers of an operation unit and a connection unit are opened at the same time.

FIG. 9 is a diagram showing an operation procedure when the side covers of the operation unit and the connection unit are opened at the same time.

### DESCRIPTION OF EMBODIMENTS

Hereinafter, embodiments that specifically disclose a surveillance camera according to the present disclosure will be described in detail with reference to the drawings as appropriate. Detailed description more than necessary may be omitted. For example, detailed description of already well-known matters and redundant description of substantially the same configuration may be omitted. This is to avoid redundancy of the following description and facilitate understanding of a person skilled in the art. The accompanying drawings and the following description are provided for a person skilled in the art to sufficiently understand the present disclosure, and are not intended to limit the subject matter described in the claims.

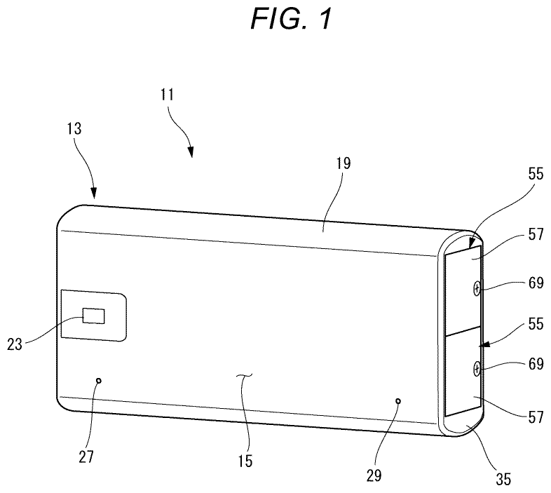

The appearance of a surveillance camera 11 according to a first embodiment will be described with reference to FIG. 1. FIG. 1 is an external perspective view of the surveillance camera 11 according to the first embodiment. An external shape of the surveillance camera 11 according to the first embodiment (that is, a shape of a housing 13) is a substantially rectangular parallelepiped shape as an example, but the external shape is not limited thereto and may be another three-dimensional shape (for example, a disk shape, a cylindrical shape, or the like).

The housing 13 of the surveillance camera 11 according to the first embodiment is formed in a substantially rectangular parallelepiped shape. A front surface 15 and a rear surface 17 of the housing 13 each have a pair of parallel surfaces along a longitudinal direction. Here. the front surface 15 is a surface on a side from which the surveillance camera 11 captures images. The rear surface 17 is a surface opposite to the side from which the surveillance camera 11 captures images, and is an attachment surface on a side from which the surveillance camera 11 is attached to any installation place.

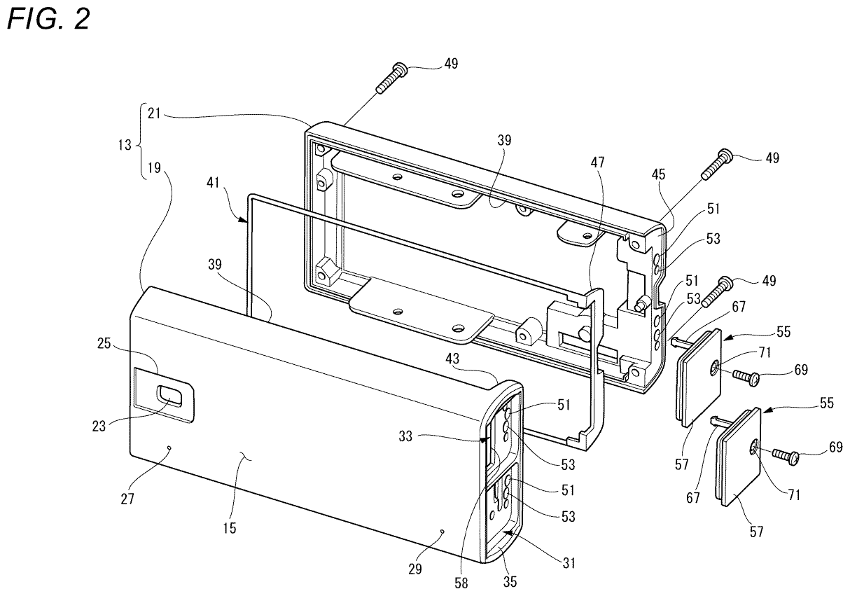

The housing 13 is formed by combining a front housing 19 on the front surface 15 side in a thickness direction and a rear housing 21 on the rear surface 17 side in the thickness direction (see FIG. 2). For example, the surveillance camera 11 is installed with the longitudinal direction aligned with a direction (hereinafter, referred to as a “horizontal direction”) along an installation surface such as a ceiling or a floor surface. The surveillance camera 11 is a so-called compact digital camera that does not require a large installation space as the surveillance camera 11 can be installed in the horizontal direction.

The housing 13 of the surveillance camera 11 according to the first embodiment has a size of, for example, about 76 mm wide, 48 mm high, and 21 mm thick. That is, in the surveillance camera 11 according to the first embodiment, a dimension in the horizontal direction is greater than a dimension in a height direction substantially orthogonal to the horizontal direction. As a result, the surveillance camera 11 can be easily installed in a place where a large installation space in the height direction cannot be secured (for example, a gap in the vicinity of the ceiling). The dimensions of the housing 13 described above are merely examples, and the present invention is not limited thereto. Regarding the dimensions of the surveillance camera 11, the dimension in the horizontal direction may be greater than the dimension in the height direction.

The surveillance camera 11 is formed such that the housing 13 is compact when viewed from the front as front and rear edges of upper and lower surfaces of the housing 13 are cut away.

A lens 23 is disposed such that a lens central axis is offset from an intersection point of a pair of diagonal lines on the rectangular front surface 15. In the first embodiment, the lens 23 is disposed on the front surface 15 close to the center of one short side. The lens central axis of the lens 23 is substantially perpendicular to the front surface 15.

The surveillance camera 11 accommodates a plurality of light-emitting elements (for example, light emission diodes (LEDs)) in the housing 13. The surveillance camera 11 is disposed such that when each of the plurality of light-emitting elements is turned on, light from the light-emitting element is transmitted through the front surface 15, and the lighting of the light-emitting element can be visually confirmed. In the housing 13, a pair of a first microphone 27 and a second microphone 29 are disposed on the front surface 15 close to two end sides of one long side, respectively.

The surveillance camera 11 includes side surfaces 35 sandwiched between the front housing 19 and the rear housing 21. The surveillance camera 11 includes an operation unit 31 (see FIG. 2) and a connection unit 33 (see FIG. 2) on one of the side surfaces 35 of the housing 13. The operation unit 31 is capable of receiving an operation by an operator or an administrator (for example, a person who uses the surveillance camera 11), or capable of connecting to an external storage medium. The connection unit 33 is capable of connecting to an external storage medium. The side surface 35 of the surveillance camera 11 according to the first embodiment is, for example, a left side with respect to an imaging direction of the surveillance camera 11.

FIG. 2 is an exploded perspective view of the surveillance camera 11 shown in FIG. 1.

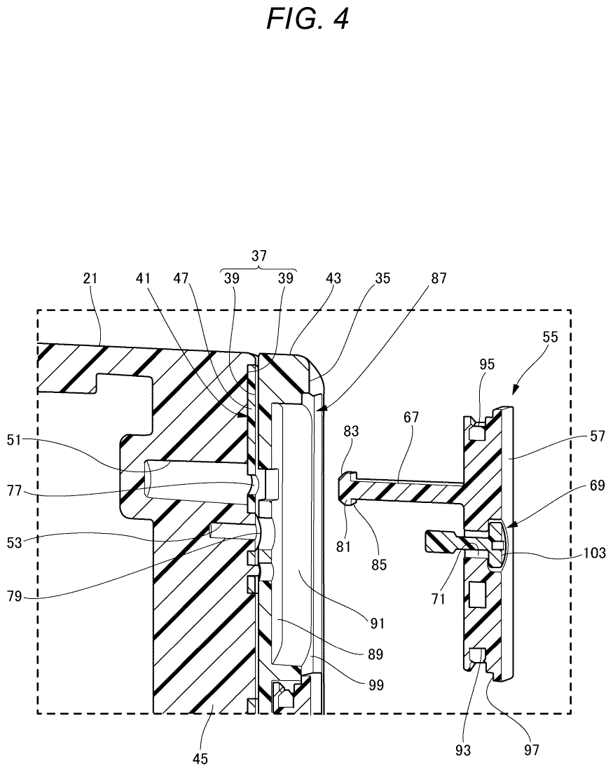

The housing 13 has a division portion 37 (see FIG. 4) between the front housing 19 and the rear housing 21. The housing 13 is assembled integrally with a substantially rectangular frame-shaped rubber packing 41 sandwiched in the division portion 37 between a division opposing surface 39 of the front housing 19 and a division opposing surface 39 of the rear housing 21. The rubber packing 41 provides a waterproof function to make the housing 13 watertight so that water does not enter the housing 13 from between the front housing 19 and the rear housing 21.

The front housing 19 has a side plate portion 43 that is bent at a substantially right angle to the front surface 15 on one side (for example, the left side) in the longitudinal direction. The side plate portion 43 constitutes the side surface 35 described above and is formed continuous with the front surface 15 of the front housing 19. That is, the front housing 19 is formed in a substantially L shape in plan view.

When the front housing 19 and the rear housing 21 are assembled, the side plate portion 43 is assembled by being overlapped from the outside and parallel to one side end portion 45 of the rear housing 21 in the longitudinal direction. A vertically long plate-shaped packing portion 47 formed on one short side of the rubber packing 41 is sandwiched in the division portion 37 between the side plate portion 43 and the one side end portion 45, thereby providing a waterproof function.

In the housing 13, when the rubber packing 41 is sandwiched between the division opposing surfaces 39 of the front housing 19 and the rear housing 21, a plurality of housing fixing screws 49 are inserted from four corners of the rear housing 21 and screwed into the front housing 19.

The side plate portion 43 is provided with storage portions 51 and screw holes 53 in the side surface 35. The storage portions 51 and the screw holes 53 are similarly provided coaxially at the one side end portion 45 of the rear housing 21. A side cover 55 is attached to the side surface 35 of the surveillance camera 11. The side cover 55 is configured to cover the operation unit 31, the connection unit 33, and the like provided on the side surface 35 with lid portions 57.

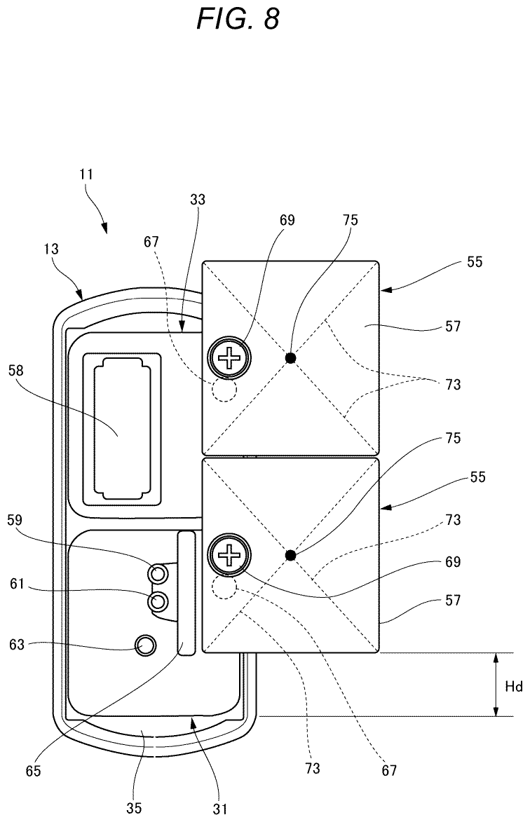

In the housing 13, for example, the connection unit 33 is provided on an upper side of the side surface 35, and the operation unit 31 is provided on a lower side of the side surface 35. The connection unit 33 includes, for example, a connection terminal for a USB terminal 58. The operation unit 31 includes, for example, a LINC lamp 59 (see FIG. 8), an ACT lamp 61 (see FIG. 8), an INITIAL/SET button 63 (see FIG. 8), and a microSD slot 65 (see FIG. 8).

The side surface 35 is formed in a substantially rectangular shape with long sides thereof aligned along a short side direction of the housing 13. In the first embodiment, the side cover 55 has two lid portions 57 attached thereto, each of which has a size approximately equal to a size obtained by dividing the side surface 35 into two equal parts along the short side direction of the housing 13. That is, the surveillance camera 11 has two side covers 55 attached to the side surface 35.

Each of the side covers 55 includes a shaft portion 67 and a fixing screw 69 in the lid portion 57.

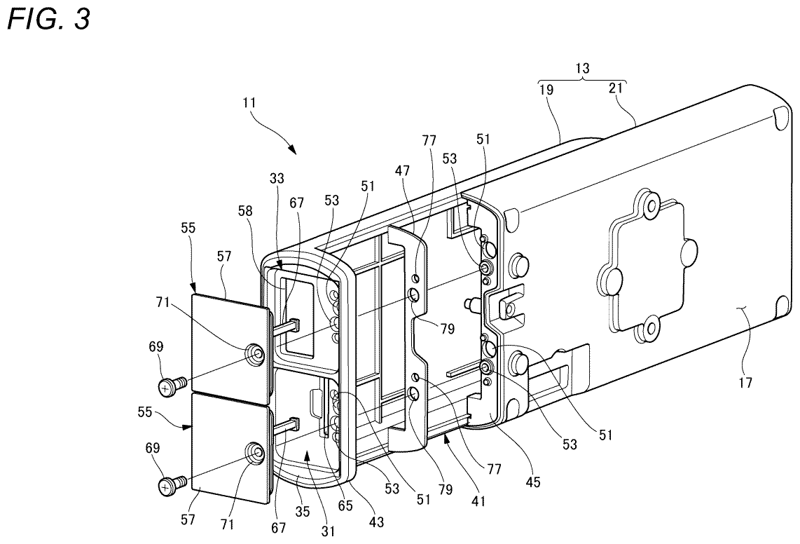

FIG. 3 is an exploded perspective view of the side surface 35 of the surveillance camera 11.

The lid portion 57 of the side cover 55 is formed in a substantially rectangular shape. The lid portion 57 has a fixing screw holding hole 71 formed therein, which is capable of rotatably holding the fixing screw 69. The fixing screw 69 inserted into the lid portion 57 passes through the side plate portion 43 and the plate-shaped packing portion 47 and is screwed into the screw hole 53 provided in the one side end portion 45 of the rear housing 21. As a result, the side cover 55 can be fixed to the side surface 35 of the housing 13.

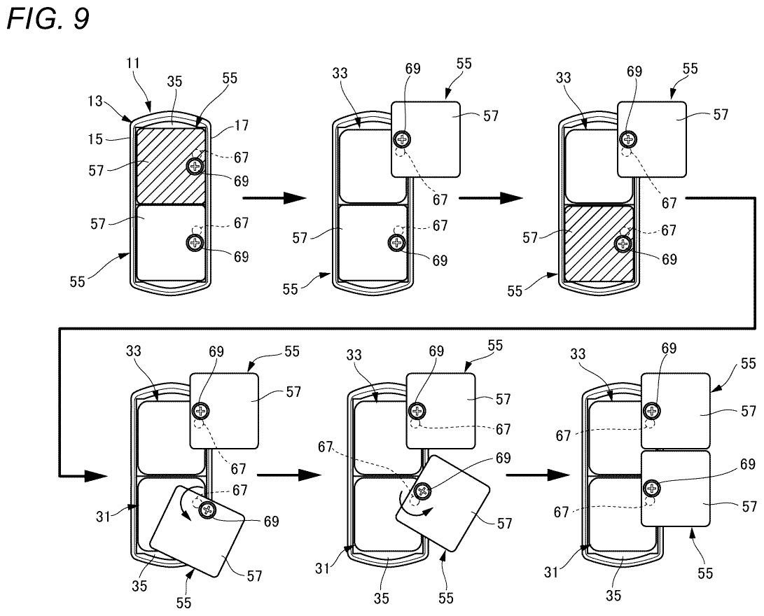

The side cover 55 has the shaft portion 67 protruding substantially perpendicularly from the lid portion 57 toward the side surface 35. The shaft portion 67 is disposed eccentrically with respect to an intersection point 75 of a pair of diagonal lines 73 (see FIG. 8) on an outer surface of the lid portion 57. The shaft portion 67 shown in the first embodiment is disposed on one side of the lid portion 57, which is attached to cover the side surface 35, aligned with the rear surface 17 of the rear housing 21, and is disposed toward an upper side (see FIG. 9). The shaft portion 67 is disposed above the fixing screw holding hole 71. The position of the shaft portion 67 and the position of the fixing screw holding hole 71 are not limited thereto.

If the shaft portion 67 is made of a soft material such as an elastic member, the shaft portion 67 may be disposed at a position corresponding to the intersection point 75 of the pair of diagonal lines 73 (see FIG. 8) of the lid portion 57.

FIG. 4 is an exploded perspective view of main parts of the side surface 35 of the housing 13 and the side cover 55. FIG. 4 shows the surveillance camera 11 when the side plate portion 43 of the front housing 19 is fixed to the one side end portion 45 of the rear housing 21.

The rubber packing 41 is sandwiched in the division portion 37 of the housing 13 to make the space between the division opposing surface 39 of the one side end portion 45 of the rear housing 21 and the division opposing surface 39 of the side plate portion 43 watertight. The rubber packing 41 has through holes 77 that have a diameter smaller than that of each of the storage portions 51 and are formed coaxially with the storage portion 51. The shaft portion 67 is formed with a diameter larger than that of each of the through holes 77. The rubber packing 41 also has a fixing screw through hole 79 formed coaxially with the screw hole 53 and through which the fixing screw 69 is inserted.

The shaft portion 67 has a retaining portion 81 formed at a tip. The retaining portion 81 catches on a peripheral edge of the through hole 77 in a direction in which the side cover 55 is pulled out from the storage portion 51, preventing the shaft portion 67 from coming off.

The retaining portion 81 is formed in a substantially truncated conical shape with a small diameter portion 83 at a tip end and a large diameter portion 85 at a rear end. An outer diameter of the large diameter portion 85 is larger than that of the shaft portion 67 and smaller than an inner diameter of the storage portion 51. That is, the surveillance camera 11 is formed such that sizes of the diameters are as follows: (inner diameter of storage portion 51)>(outer diameter of large diameter portion 85 in retaining portion 81)>(outer diameter of shaft portion 67)>(inner diameter of through hole 77).

As described above, in the surveillance camera 11, even when the side cover 55 is pulled out by an operator at the time of an operation of the operation unit 31, a connection operation to the connection unit 33, or the like, the retaining portion 81 can be caught in the through hole 77 to prevent the side cover 55 from falling off.

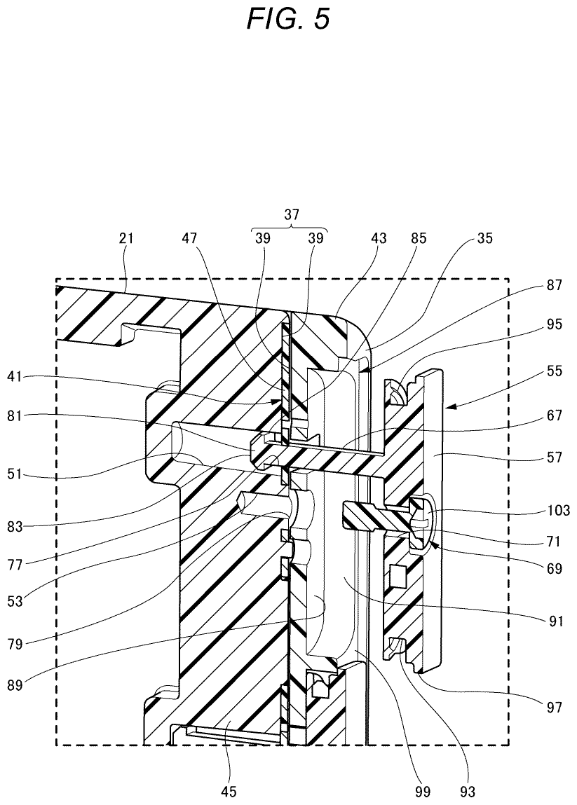

FIG. 5 is a perspective cross-sectional view of main parts when the shaft portion 67 of the side cover 55 is attached to the side surface 35 of the housing 13.

The side cover 55 has the shaft portion 67 passing through the through hole 77 and the shaft portion 67 inserted into a rear side of the storage portion 51, so that the lid portion 57 is attached approximately parallel to the side surface 35 of the housing 13. The side cover 55 attached to the side surface 35 covers the operation unit 31 and the connection unit 33 with the lid portion 57. In the side cover 55, an outer periphery of the shaft portion 67 passing through the through hole 77 is held by an elastic restoring force of the through hole 77 in a diameter-reducing direction.

As a result, in the surveillance camera 11, the lid portion 57 of the side cover 55 is attached to the housing 13 so as to be movable toward and away from the side surface 35 and rotatable therewith. In the surveillance camera 11, when the side cover 55 is pulled out to any position, the shaft portion 67 having a diameter larger than that of the through hole 77 is supported by the through hole 77, so that the side cover 55 can be held at any pulled out position.

The operation unit 31 and the connection unit 33 provided on the side surface 35 are provided on a bottom surface 89 of a substantially rectangular lid fitting recess 87 formed by recessing the side surface 35. A height of an inner peripheral surface 91 of the lid fitting recess 87 is substantially the same as a thickness of the lid portion 57 along the pull-out direction of the side cover 55.

A peripheral groove 93 is formed on an outer periphery of the lid portion 57. An annular lid packing 95 is attached to the peripheral groove 93. In the lid packing 95, the lid portion 57 is attached to the lid fitting recess 87, and the inner peripheral surface 91 of the lid fitting recess 87 and an outer peripheral surface of the lid portion 57 are brought into a watertight state. At this time, in the side cover 55, the shaft portion 67 reaches the deepest portion of the storage portion 51, and a back surface of the lid portion 57 approaches the bottom surface 89 of the lid fitting recess 87.

As a result, the operation unit 31 and the connection unit 33 is in a watertight state from the outside of the housing 13. The insertion of the lid portion 57 into the lid fitting recess 87 is restricted by a back surface peripheral frame portion 97 abutting against an entrance step portion 99 of the lid fitting recess 87. The lid portion 57 is fixed to the side surface 35 of the housing 13 by screwing the fixing screw 69 into the screw hole 53.

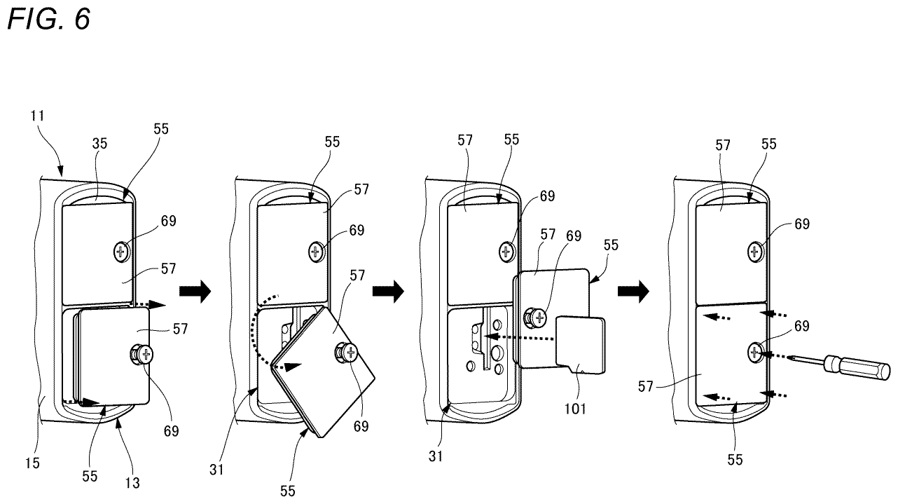

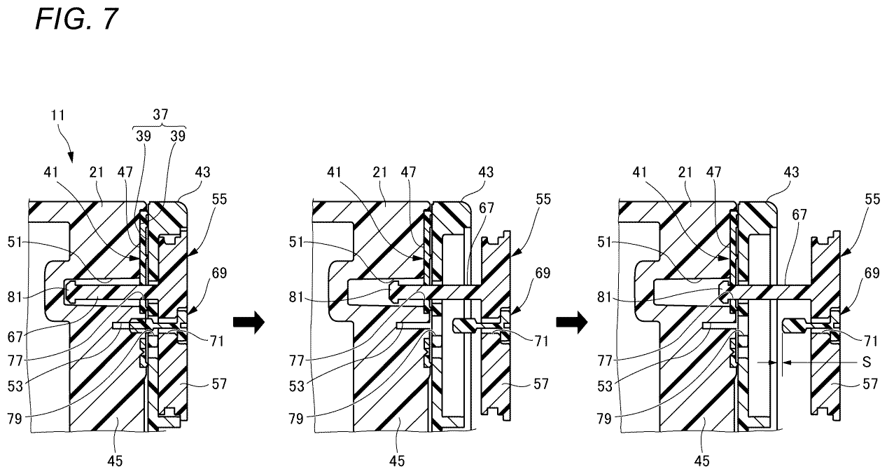

Next, a procedure for opening and closing a lid portion of the surveillance camera 11 will be described with reference to FIGS. 6 and 7. FIG. 6 is an explanatory diagram showing an operation procedure when opening and closing the side cover 55. FIG. 7 is a cross-sectional view of main parts showing the operation procedure when opening and closing a side cover.

In the surveillance camera 11, the side cover 55 is opened in operations such as confirmation of the LINC lamp 59 and the ACT lamp 61, an operation of the INITIAL/SET button 63, and attachment of a microSD card 101 to the microSD slot 65, which are performed when installing the surveillance camera 11 or performing maintenance on the surveillance camera 11.

For example, when the side cover 55 of the operation unit 31 is opened, an operator loosens the fixing screw 69 that fixes the lower lid portion 57. The operator releases the screwing of the fixing screw 69 to pull out the lid portion 57 to the outside of the housing 13. In the side cover 55, when the shaft portion 67 is pulled out by any length, the retaining portion 81 is caught on the peripheral edge of the through hole 77, and pull-out is restricted. When the side cover 55 is pulled out by any length, the side cover 55 is rotatably supported by the through hole 77 with the shaft portion 67 as a rotation center.

The side cover 55 is moved by the operator to a position where a tip of the fixing screw 69 held by the lid portion 57 does not interfere with the side surface 35. Specifically, the side cover 55 is moved to a position where the fixing screw 69 does not interfere with the outermost surface, which is the outermost side, of the side plate portion 43 of the front housing 19. That is, regarding the fixing screw 69, there is a predetermined gap S between the housing 13 and the fixing screw 69 when the shaft portion 67 is prevented from coming off. A length of the fixing screw 69 may be set to such a length that the tip of the fixing screw 69 does not interfere with the housing 13 when the lid portion 57 is rotated.

when the side cover 55 is rotated by 180° about the shaft portion 67 by the operator, the lid portion 57 rotates from a pulled-out position toward the rear surface 17 side of the housing 13, exposing and allowing an operation of the operation unit 31. When the operation unit 31 is exposed so as to be operable, the side cover 55 is held by the shaft portion 67 being tightened by the elastic restoring force of the through hole 77 in the diameter-reducing direction.

This allows the operator to rotate the side cover 55 to expose operation parts such as the operation unit 31 and the connection unit 33, and to operate the operation unit 31 and insert or remove the microSD card 101 into and from the microSD slot 65 of the connection unit 33, without having to support the open side cover 55 with his or her hand.

After the completion of the operation, the operator rotates the side cover 55 by 180° again, and pushes the lid portion 57 in a direction approaching the side surface 35. The operator tightens the fixing screw 69 into the screw hole 53 and fixes the lid portion 57 to the side surface 35, thereby completing the opening and closing of the operation unit 31. Although the procedure for opening and closing the side cover 55 described above has been described by taking a procedure for opening and closing the operation unit 31 as an example, the procedure for opening and closing the connection unit 33 is similar.

Next, procedures for opening and closing the two side covers 55 will be described with reference to FIGS. 8 and 9. FIG. 8 is a side view of the housing 13 when the side covers 55 of an operation unit 31 and the connection unit 33 are opened at the same time. FIG. 9 is an explanatory diagram showing an operation procedure when the side covers 55 of the operation unit 31 and the connection unit 33 are opened at the same time.

In the surveillance camera 11, the side cover 55 covering the operation unit 31 and the side cover 55 covering the connection unit 33 can be opened at the same time. The operator can open (put into an open state) the operation unit 31 and the connection unit 33 at the same time by rotating the two side covers 55 one by one toward the rear surface 17 side of the housing 13.

The operator releases a screwing state of the fixing screws 69 of the side covers 55 covering the operation unit 31 and the connection unit 33, respectively. The operator pulls out and rotates one of the side covers 55. The operator pulls out and rotates the other side cover 55.

In the example shown in FIG. 9, for example, the operator pulls out the upper side cover 55 covering the connection unit 33 and rotates the lid portion 57 of the pulled-out side cover 55 by 180°. The operator pulls out the lid portion 57 of the lower side cover 55 and rotates the lid portion 57 of the pulled-out lower side cover 55 counterclockwise by 180°. As a result, the two side covers 55 covering the operation unit 31 and the connection unit 33 are held in an open state at the same time.

In addition, in the lid portion 57 in an open state, since the shaft portion 67 is also disposed toward the upper side (an upper side in the drawing), a lower side portion Hd of the side surface 35 (see FIG. 8) can be exposed by a width in the thickness direction of the housing 13 without overlapping with the lid portion 57, by the amount that the lid portion 57 is offset upward.

In the surveillance camera 11 according to the first embodiment, when the lid portion 57 is rotated by 180° about the shaft portion 67, a portion of the lid portion 57 on the front surface 15 side of the housing 13 covering the operation unit 31, the connection unit 33, and the like on the front surface side of the housing 13 is rotated and moved outward from the side surface 35 toward the rear surface 17 of the housing 13. That is, in the surveillance camera 11, since the shaft portion 67 is offset toward the rear surface 17 side, the operation parts such as the operation unit 31 and the connection unit 33 can be exposed to a larger extent.

After completing operations for the operation unit 31 and the connection unit 33, the operator rotates the side cover 55 covering the operation unit 31 by 180° in the clockwise direction and pushes the lid portion 57 in the direction approaching the side surface 35 in a procedure reverse to the procedure described above. Similarly, the operator rotates the side cover 55 covering the connection unit 33 by 180° and pushes the lid portion 57 in the direction approaching the side surface 35. The operator tightens the fixing screws 69 of the two respective side covers 55 into the screw holes 53, fixes the lid portions 57 to the side surface 35, and completes the opening and closing of the side covers 55.

As described above, even when the surveillance camera 11 according to the first embodiment has an opening and closing structure in which the two side covers 55 are disposed adjacent to each other in a vertical direction of the side surface 35, the two side covers 55 can be opened at the same time.

In the surveillance camera 11 according to the first embodiment, although the two shaft portions 67 are disposed on the rear surface 17 side and on the upper side (the upper side in the drawing), this is merely an example, and the present invention is not limited thereto. An eccentric position of the lid portion 57 may be provided eccentrically with respect to the intersection point 75 of a pair of diagonal lines of the lid portion 57. Further, the eccentric position of each of the two shaft portions 67 may not be the same with respect to the intersection point 75. For example, in the surveillance camera 11, one shaft portion 67 may be provided on the rear surface 17 side and the other shaft portion 67 may be provided eccentrically on the front surface 15 side.

In the first embodiment, although an example of a surveillance camera 11 having two side covers 55 on the side surface 35 is shown, the number of side covers 55 is not limited thereto and may be one or three or more.

As described above, the surveillance camera 11 according to the first embodiment includes a housing 13, storage portions 51 provided in the housing 13, at least one side cover 55 (an example of a cover) attached to the housing 13, a rubber packing 41 (an example of an elastic portion) disposed between the housing 13 and the side cover 55 and having through holes 77, and a shaft portion 67 having a diameter larger than that of each of the through holes 77 and protruding from the side cover 55 toward the storage portions 51 of the housing 13 facing the side cover 55. The through hole 77 rotatably holds the shaft portion 67 that is inserted into the storage portion 51 through the through hole 77.

As a result, in the surveillance camera 11 according to the first embodiment, the shaft portion 67 of the side cover 55, which is attached to the side surface 35 of the housing 13 and covers the operation unit 31, the connection unit 33, and the like, can be rotatably held by the through hole 77 of the rubber packing 41. Therefore, when installing the surveillance camera 11 or performing maintenance on the surveillance camera 11, an operator does not have to hold the lid portion 57 in an open state with one hand, and can perform work on the operation unit 31, the connection unit 33, and the like without completely removing the side cover 55. In addition, the operator does not need to take care to prevent the side cover 55 from being lost when the side cover 55 is removed during work. Further, the surveillance camera 11 can prevent accidents that may occur when the operator tries to pick up the side cover 55 when the side cover 55 falls, and helps the operator to perform his or her work more easily and safely.

As described above, the side cover 55 of the surveillance camera 11 according to the first embodiment is formed in a substantially rectangular shape. The shaft portion 67 is provided eccentrically with respect to an intersection point 75 of a pair of diagonal lines of the side cover 55 (that is, the lid portion 57). As a result, in the surveillance camera 11 according to the first embodiment, by rotating the lid portion 57 with the side cover 55 pulled out, the position of the lid portion 57 can be moved and maintained at a position away from the position covering the operation unit 31, connection unit 33, and the like. That is, after pulling out the side cover 55, the operator can rotate the lid portion 57 to keep operation parts such as the operation unit 31 and the connection unit 33 exposed.

It is desirable that an eccentric position of the shaft portion 67 is disposed at a position away from the intersection point 75 of a pair of diagonal lines 73, that is, on an inner side close to the contour of the lid portion 57. As a result, the side cover 55 makes it possible to expose the operation parts such as the operation unit 31 and the connection unit 33 that are covered to a larger extent.

As described above, the shaft portion 67 of the surveillance camera 11 according to the first embodiment has, at a tip portion inserted into the storage portion 51, a retaining portion 81 that has a diameter larger than that of the shaft portion 67 and catches on a peripheral edge of the through hole 77 to prevent the shaft portion 67 from coming off. As a result, the surveillance camera 11 according to the first embodiment can prevent the side cover 55 from being completely removed by the operator.

As described above, the side cover 55 (that is, the lid portion 57) of the surveillance camera 11 according to the first embodiment has a fixing screw 69 rotatably held therein, the fixing screw 69 being screwed into a screw hole 53 provided in the housing 13. The fixing screw 69 has a length shorter than a length by which the shaft portion 67 can be pulled out. As a result, the surveillance camera 11 according to the first embodiment can avoid interference between the housing 13 and the fixing screw 69 that fixes the side cover 55 to the housing 13 when the lid portion 57 is rotated by the operator.

As described above, the surveillance camera 11 according to the first embodiment has a plurality of side covers 55 provided adjacent to the housing 13. The shaft portions 67 of the plurality of side covers 55 are each provided eccentrically with respect to the intersection point 75 of the pair of diagonal lines of the side cover 55 (that is, the lid portion 57). As a result, in the surveillance camera 11 according to the first embodiment, even in a case in which different side covers 55 cover a plurality of operation parts, such as the operation unit 31 and the connection unit 33, on the side surface 35, the shaft portions 67 of the plurality of side covers 55 can be rotatably held by the through holes 77 of the rubber packing 41. Therefore, when installing the surveillance camera 11 or performing maintenance on the surveillance camera 11, the operator can open the plurality of side covers 55 at the same time.

Although various embodiments have been described above with reference to the accompanying drawings, the present disclosure is not limited to such examples. It is apparent to a person skilled in the art that various changes, modifications, substitutions, additions, deletions, and equivalents can be conceived within the scope of the claims, and it is understood that such modifications also belong to the technical scope of the present disclosure. The components in the various embodiments described above may be optionally combined without departing from the gist of the invention.

The present application is based on Japanese Patent Application (Japanese Patent Application No. 2022-017266) filed on Feb. 7, 2022, and the contents thereof are incorporated herein by reference.

### INDUSTRIAL APPLICABILITY

The present disclosure is useful as a surveillance camera that improves the ease of attaching and detaching an external storage medium to and from a surveillance camera.

### REFERENCE SIGNS LIST

11 surveillance camera
13 housing
15 front surface
17 rear surface
31 operation unit
33 connection unit
35 side surface
37 division portion
39 division opposing surface
41 rubber packing
51 storage portion
53 screw hole
55 side cover
57 lid portion
67 shaft portion
69 fixing screw
73 diagonal line
75 intersection point
77 through hole
81 retaining portion

1. A surveillance camera comprising:
a housing;
a storage portion that is provided in the housing;
at least one cover that is attached to the housing;
an elastic portion that is disposed between the housing and the cover and that has a through hole; and
a shaft portion that has a diameter larger than that of the through hole and that protrudes from the cover toward the storage portion of the housing facing the cover, wherein
the through hole rotatably holds the shaft portion that is inserted into the storage portion through the through hole.

2. The surveillance camera according to claim 1, wherein
the cover is formed in a substantially rectangular shape, and
the shaft portion is provided eccentrically with respect to an intersection point of a pair of diagonal lines in the cover.

3. The surveillance camera according to claim 2, wherein
the shaft portion has, at a tip portion inserted into the storage portion, a retaining portion that has a diameter larger than that of the shaft portion and catches on a peripheral edge of the through hole to prevent the shaft portion from coming off.

4. The surveillance camera according to claim 3, wherein
the cover has a fixing screw rotatably held therein, the fixing screw being screwed into a screw hole provided in the housing, and
the fixing screw has a length shorter than a length by which the shaft portion is capable of being pulled out.

5. The surveillance camera according to claim 4, wherein
a plurality of the covers are provided adjacent to the housing, and
the shaft portions of the plurality of covers are each provided eccentrically with respect to the intersection point of the pair of diagonal lines in the cover.
